(19) United States
(12) Patent Application Publication
(10) Pub. No.: US 2014/0129343 A1
(43) Pub. Date: May 8, 2014

(54) DYNAMIC TARGETED ADVERTISING AVATAR

(71) Applicant: MICROSOFT CORPORATION, Redmond, WA (US)

(72) Inventors: Diana Finster, Seattle, WA (US); Enrique de la Garza, Sammamish, WA (US); Alexei Pineda, Bellevue, WA (US); Sean Alexander, Sammamish, WA (US)

(73) Assignee: MICROSOFT CORPORATION, Redmond, WA (US)

(21) Appl. No.: 13/671,814

(22) Filed: Nov. 8, 2012

(51) Int. Cl. G06Q 30/02

(52) U.S. Cl. CPC G06Q 30/0269
USPC 705/14.66

(57) ABSTRACT

A dynamic, personalized advertising avatar based on a user's own avatar used in an online service is used to provide branded advertising in a virtual context. A definition of a user avatar with user attributes is acquired, and custom attributes for a dynamic user-based avatar are received from an advertiser. Dynamically generated user-based avatars are created having at least a portion of user attributes of the user avatar and a portion of the custom attributes, so that the resulting custom avatar is recognizable to the user but represents a product brand or service. Information is then acquired regarding user activity on a device capable of displaying the dynamically generated user-based advertising avatar and advertisements generated based on the dynamically generated user-based advertising avatar and the targeting information. The advertisement is then rendered on the user device using the dynamically generated user-based advertising avatar.

### BACKGROUND

An avatar may be a computer-generated image which represents a user in a virtual environment. The avatar may depict an image of the user that is highly representative of what the user actually looks like or it may be a character (e.g. human, fanciful, animal, animated object) with varying degrees of resemblance to the user or none at all. Avatars may be three-dimensional (3D) or two-dimensional (2D).

Users of various online services have been provided with the ability to define their own avatars as representations of themselves in the online service. For example, the XBOX Live® service allows users to create a custom avatar through a console or web interface, and use that avatar as a representation of their “online” self. Users generally find their own avatar familiar in different online contexts.

Advertisers seek to deliver personalized, engaging branded content to a relevant target audience. Advertisers also employ targeted online advertising to market products and services. Online advertisements may be presented within web pages, search engine search results, online video games through product placement, within email messages, or the like. Creating personalized advertising content allows the advertisers to build a one-to-one relationship with their target audience.

### SUMMARY

Technology is described to provide an dynamic, personalized advertising avatar based on a user's own avatar used in an online service. The technology provides for acquiring a definition of a user avatar with user attributes, and receiving custom attributes from an advertiser. Advertising information from the advertiser determines the definition of a dynamically generated user-based advertising avatar and its use in an advertising campaign. Dynamically generated user-based avatars are created having at least a portion of user attributes of the user avatar and a portion of the custom attributes, so that the resulting custom avatar is recognizable to the user but represents a product brand or service. Information is then acquired regarding user activity on a device capable of displaying the dynamically generated user-based advertising avatar and advertisements generated based on the dynamically generated user-based advertising avatar and the targeting information. The advertisement is then rendered on the user device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an exemplary system in accordance with embodiments of the present disclosure.

FIG. 2 is a flowchart describing one embodiment of a process for providing targeted advertising to one or more users.

FIG. 3 is a flowchart describing one embodiment of a process for determining whether an advertisement should be presented to a user.

FIG. 4 is a flow chart describing one embodiment of a process for determining appropriate custom attributes to add to a user avatar.

FIG. 5 is a flow chart describing one embodiment of a process for dynamically rendering a user.

FIG. 6 is a flow chart describing one embodiment of a process for determining user interaction with a custom avatar.

FIGS. 7A-7D illustrate an example of an advertisement in accordance with embodiments of the present disclosure.

FIG. 8 illustrates an example of an advertisement in accordance with embodiments of the present disclosure on a television.

FIG. 9 illustrates an example of an advertisement in accordance with embodiments of the present disclosure on a mobile device.

FIG. 10 illustrates an example of an advertisement in accordance with embodiments of the present disclosure on a web browser.

FIG. 11 illustrates an example of a computing environment in accordance with embodiments of the present disclosure.

FIG. 12 illustrates an example of a computing environment in accordance with embodiments of the present disclosure.

### DETAILED DESCRIPTION

Technology is described for providing dynamic personalized avatar. In one embodiment, information associated with a user is acquired, which may include user profile information, avatar attributes, demographic information, behavioral information, contextual information, etc. An avatar may be generated based at least in part on the information associated with the user. Based on the avatar and the information associated with the user, an advertisement is dynamically generated and provided to the user that features the user's avatar promoting a certain brand of product and/or service. Subsequently, the user may interact with the advertisement, e.g., by clicking on the avatar.

A dynamic, personalized advertising avatar based on a user's own avatar used in an online service is used to provide branded advertising in a virtual context. A definition of a user avatar with user attributes is acquired, and custom attributes for a dynamic user-based avatar are received from an advertiser. Advertising information from the advertiser determines the definition of a dynamically generated user-based advertising avatar and its use in an advertising campaign. Dynamically generated user-based avatars are created having at least a portion of user attributes of the user avatar and a portion of the custom attributes, so that the resulting custom avatar is recognizable to the user but represents a product brand or service. Generation is dynamic in that advertising avatars are created as needed and for different users, thereby representing a familiarity to the user. Information is then acquired regarding user activity on a device capable of displaying the dynamically generated user-based advertising avatar and advertisements generated based on the dynamically generated user-based advertising avatar and the targeting information. The advertisement is then rendered on the user device using the dynamically generated user-based advertising avatar.

For example, a user is watching an episode of a TV show “ABC” on a device (e.g., Xbox). During an advertising break, the user is presented with an advertisement with an avatar having one or more characteristics which allow the user to recognize that it is based on the user's avatar attributes, but is now wearing a shirt with “XYZ” brand label on the shirt. The user can obtain further information about the “XYZ” brand by interacting with the avatar. For example, the user can click on the avatar and may be presented with additional information about the brand, e.g., a web site, video, etc. The avatar can be dynamically generated as needed for each advertisement presented. By employing the avatar as a digital spokesperson o promote a certain brand of clothing, the advertiser for that brand is able to deliver an engaging and interactive advertising experience to the user that is likely to result in conversions for the advertiser.

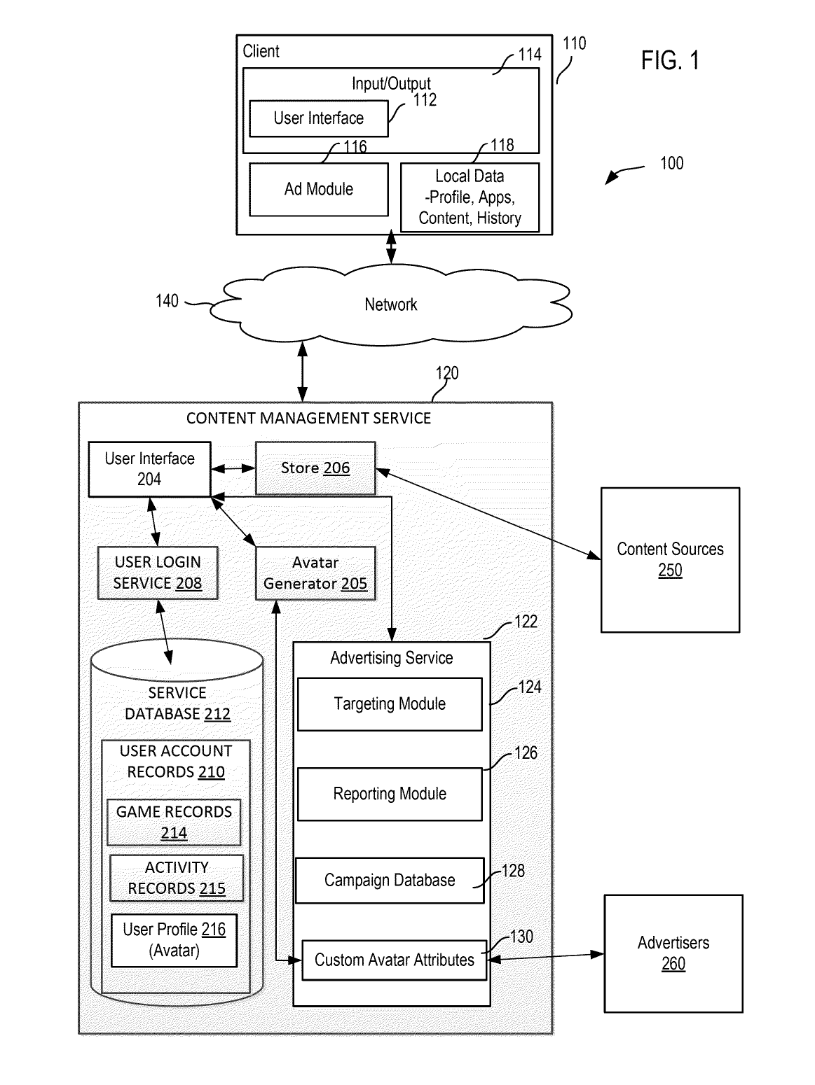

FIG. 1 depicts an exemplary system 100 in accordance with embodiments of the present disclosure. System 100 may be used to provide targeted interactive advertisements using dynamically generated user-based advertising avatars in advertising targeted to a user. In one embodiment, a dynamically generated user-based advertising avatar promotes a brand of product or service, and comprises an interactive advertisement for the product or service with which a user can interface. The advertisements provided to the user may be presented in a wide range of applications or environments. For example, the advertisements could be presented within an instant messaging environment, a social networking website, a gaming experience provided by a game system or an online game service, a mobile experience via a mobile device, a PC experience via a desktop computer or a laptop computer.

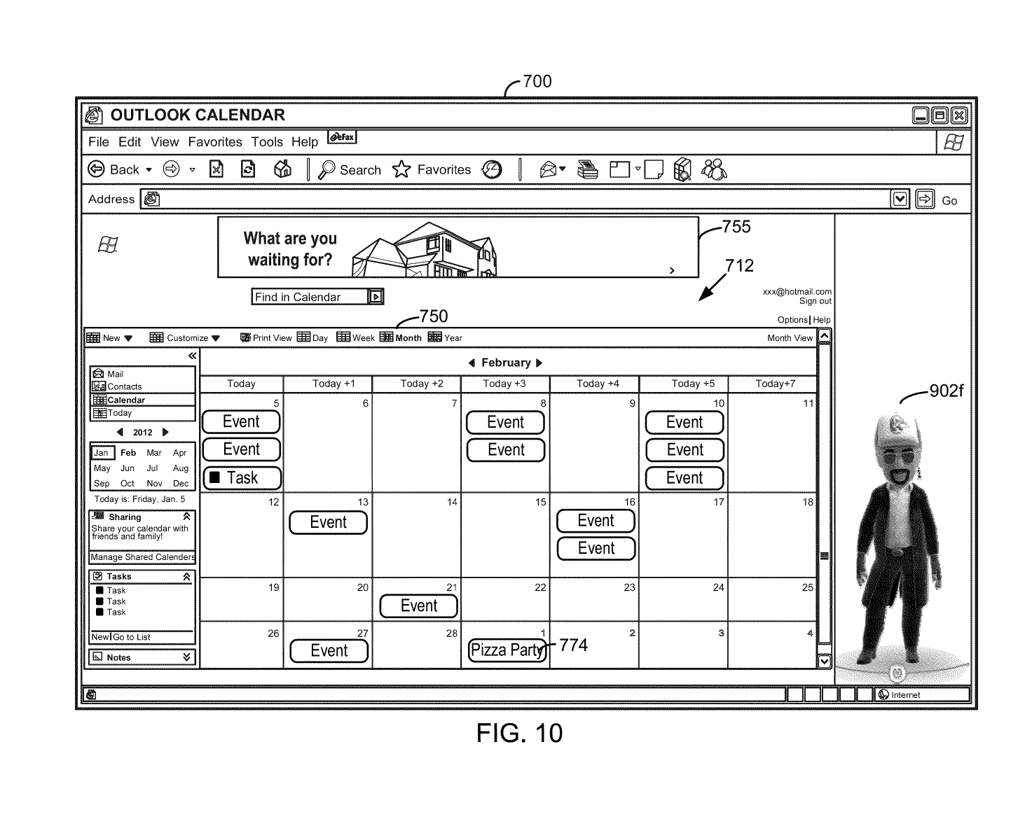

As shown in FIG. 1, system 100 may include a client device 110 and a content management service 120. Service 120 may be provided by a single processing device or multiple distributed processing devices. The client device 110 and content management service 120 are coupled via a network 140. As non-limiting examples, client device 110 may be any of a number of different types of devices owned and operated by a user, such as, for instance, a desktop computer, a laptop computer, a gaming system or console, a mobile device, or the like. In one embodiment, client device 110 may include hardware components and/or software components which may be used to execute an operating system and applications such as gaming applications, content presentation applications, mobile applications, or the like. In one embodiment, client device 110 and service 120 may include any type of computing device, such as computer 310 described with reference to FIG. 10. Alternatively, the client device 110 and service 120 may be provided on a single processing device.

Although one client device 110 is illustrated, it should be understood that a plurality of client devices 110 may be coupled via a network 140 to a content management service 120. Content management service 120 may provides a number of different services to each of the client devices. Content management service 120 may include a collection of one or more servers that are configured to dynamically serve targeted interactive advertisements to a user in accordance with embodiments of the present disclosure. Network 140 may be implemented as the Internet or other WAN, a LAN, intranet, extranet, private network or other network or networks.

It should be understood that this and other arrangements described in system 100 are set forth as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

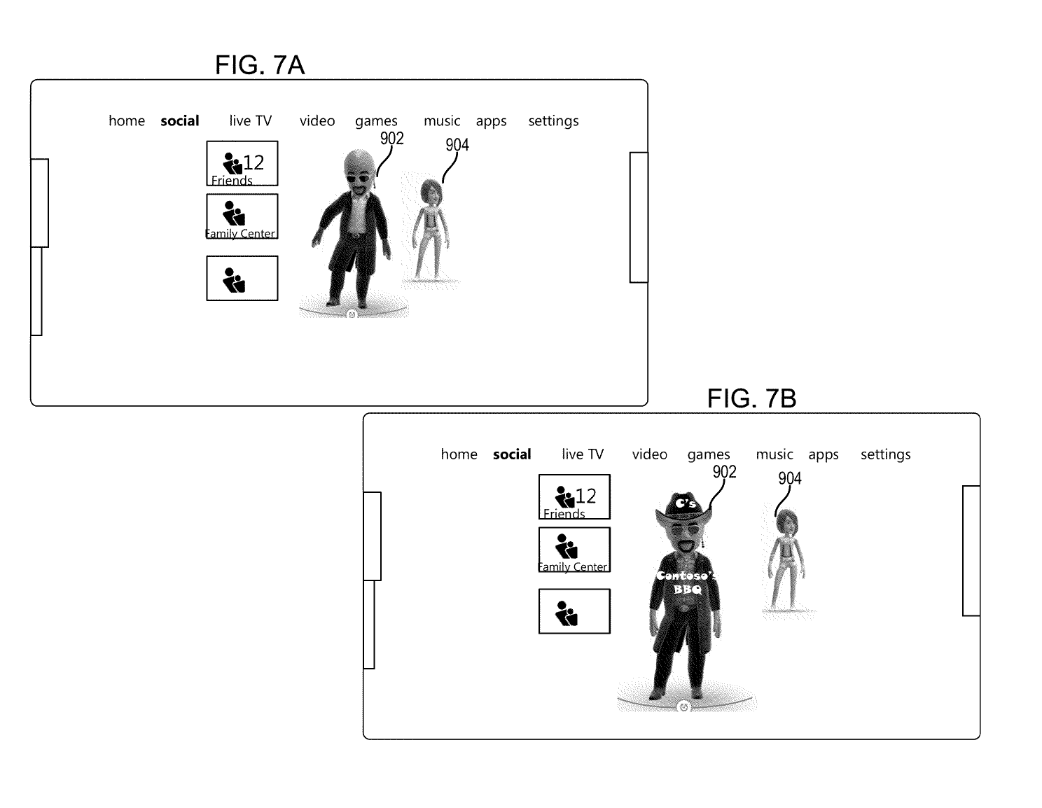

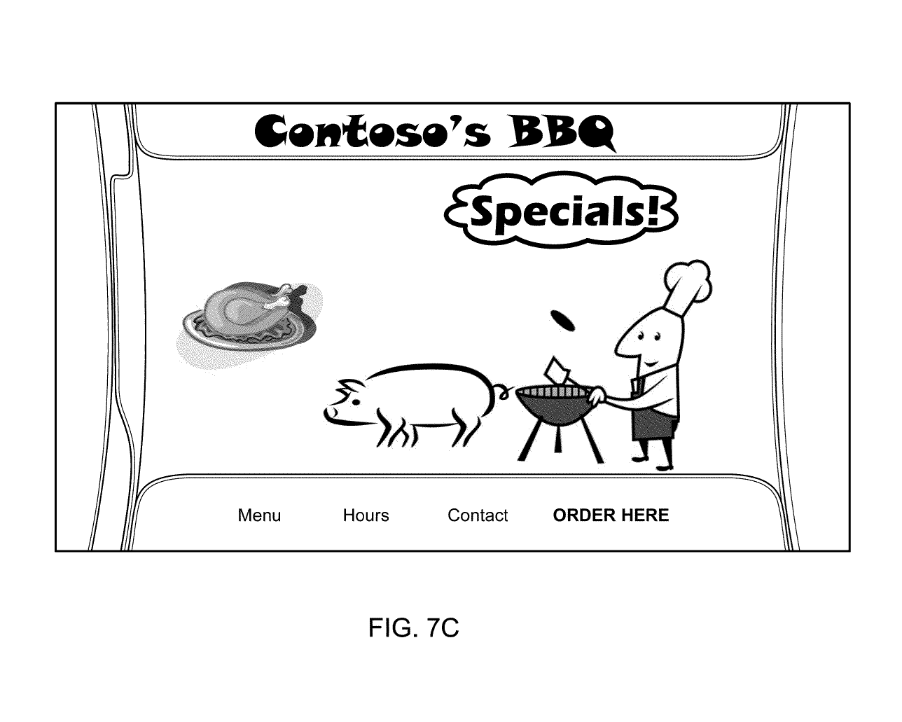

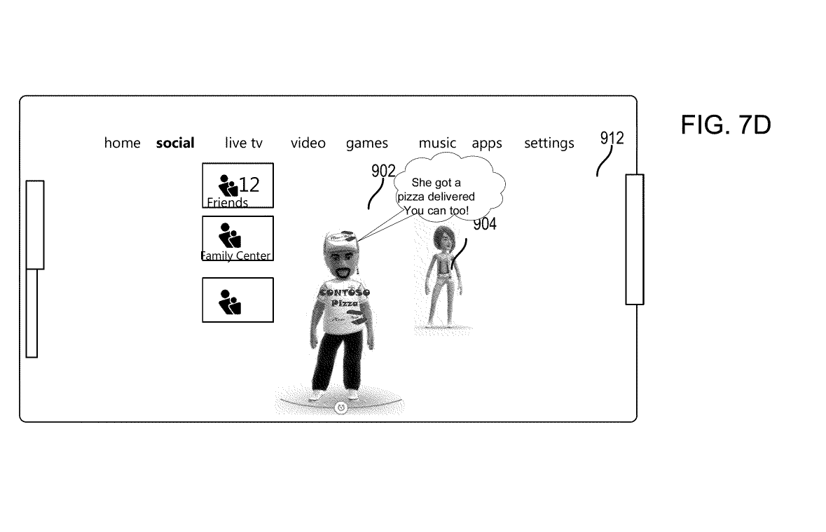

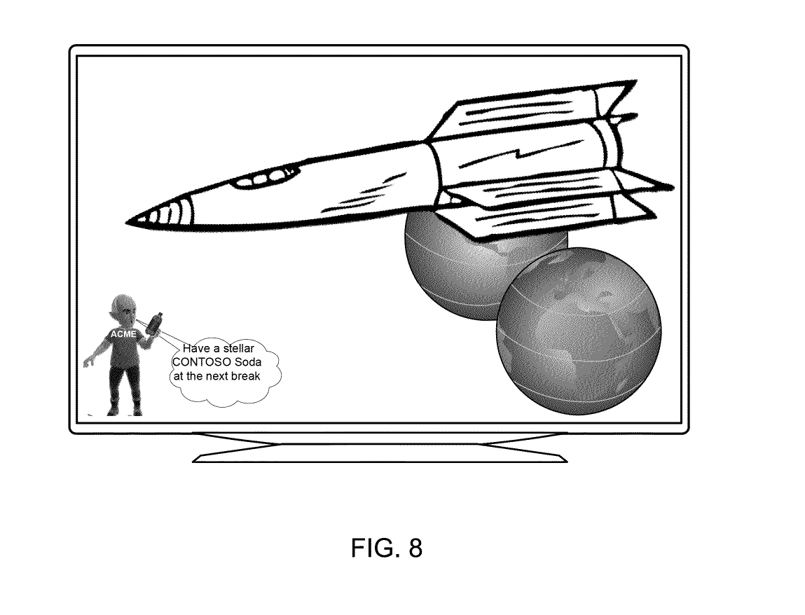

As shown in FIG. 1, client device 110 may include a user interface 112 allowing a user to select content, games, applications, etc. on client device 110. Components of a user interface 112 may include window, icons, and other display elements, including user avatars and dynamically generated user-based advertising avatars. It will be understood that some systems allow users to create a custom avatar to represent the user in the context of the system. The Xbox LIVE® system from Microsoft Corporation is one such system. In this context, the user interface may include an interactive, animated avatar representing the user, and display other avatars representing other users of the system. For example, as shown in FIG. 7A, the user's avatar and avatars of the user's friends or family are displayed. The user interface may change based on an application being run on the client device 110. For example, a web user interface (FIG. 10) may be presented as well as a broadcast audio/video interface (FIG. 8).

Client device 110 may include an input/output module 114 that allows a user to input data, commands, etc, and ouputs the user interface and content in the form of applications and audio/visual data. As non-limiting examples, input/output module 114 may include a keypad, a keyboard, a controller, a joystick, a mouse, a touch screen, or the like. Each client device may include or be coupled to a display such as a built in display, a television, a monitor, a high-definition television (HDTV), or the like. The input/output module may capture image and audio data relating to one or more users and/or objects. For example, voice and gesture information relating to partial or full body movements, gestures, and speech of a user of client device 110 may be used to provide input. In one embodiment, a user of client device 110 may interact with an advertisement provided to the user based on information captured in the form of voice and gesture inputs. For example, input/output module 114 may detect a voice command from the user, e.g., “more information.” In response to detecting the user's voice command, the user may be redirected to content associated with the product or service, e.g., the advertiser's web site. In another example, input/output module 114 may detect the user's hand gesture pointing at the advertisement. In response to detecting the user's hand gesture, a video related the product or service may be played to the user.

Client device 110 may include an ad module 116 which interfaces with the input/output module 114 to provide advertising content as described herein. The advertising may be provided in the context of the content that a user is engaged with. For example, in a game context, the ad module may be configured to present advertising functions at appropriate and non-intrusive points in the game. During a broadcast program with pre-scheduled breaks, the ad module may be configured to present advertising during the break and if broadcast advertising is present in the break, may be configured to conincide with the broadcast advertising. In one embodiment, ad module 116 may be part of an operating system. In other embodiments, ad module 116 may reside outside of the operating system.

The ad module may be tailored to the processing capabilities of the client device 110. For example, an ad module 116 for a mobile device may include different capabilities than one for a gaming console.

Local data 118 includes stored programming content, cached programming content, stored applications, and user inforamtion. Where the client includes applications for accessing the Internet, local data may include the user's activity history, including which items of content the user has engaged with or what the user may have searched for on commerce sites. History may include content consumption preferences such as viewing and listening habits, and the user's application usage history, such as which gams a user regularly plays. This information may be provided to ad module 116 (and or advertising service 122) for use in determining appropriate advertising for a user of the client device 110.

In one embodiment, ad module 116 may acquire information associated with a user of client device 110. For example, ad module 116 may retrieve user profile information associated with the user from local data 118. User profile information associated with the user may include a user ID, an email address, a name, a machine or device ID, or the like. Ad module 116 may provide advertisements that correspond with the user's usage traits to the user while advertisements that do not correspond with the user's personality will not.

In one embodiment, ad module 116 may access behavioral information accessible in the local data 118. As disclosed above, information associated with a user of client device 110 may be acquired from various sources by various means. The information associated with a user may include user profile information (e.g., user ID, email address, etc.), user's avatar attributes, user's behavioral information, etc. In one embodiment, the information associated with a user of client device 110 may be sent to content management service 120 for further processing. In one embodiment, content management service 120 may be configured to provide targeted and interactive advertisements to a user of client device 110 based on the information associated with the user, as will be described below.

Referring to FIG. 1, a content management service 120 may be coupled to each of the respective client devices 110 through network 140. Content management service 120 of system 100 may include user login service 208, which is used to authenticate a user on client devices. During login, login service 208 obtains an identifier associated with the user and a password from the user as well as a console identifier that identifies the client that the user is operating. The user is authenticated by comparing them to user records 210 in a database 212.

Content management service 120 may provide a user interface 104 to allow users of client devices to access various aspects of the content management service 120 such as the avatar module 205, content store 206 and user records 210. The user interface 204 may be provided as a separate interface through, for example, a web browser interface or a dedicated client interface provided on the client device 110. An example of a dedicated client interface is the user interface provided on the Xbox 360® console device.

User records 210 can include additional information about the user such as game records 214, activity records 215 and user profile data 216. Game records 214 include information for a user identified by a user id and can include statistics for a particular game, achievements acquired for a particular game and/or other game specific information as desired. Activity records can include records of user activity including which applications a user has engaged, content a user has engaged, advertisements a user has engaged, and other activity performed by the user on the client. User profile data 216 may include, for example, information on the user such as location, interests, friends, purchases and the like. A friends list includes an indication of friends of a user that are also connected to or otherwise have user account records with console management service 120. The term “friend” as used herein can broadly refer to a relationship between a user and another user, where the user has requested that the other gamer consent to be added to the user's friends list, and the other gamer has accepted. User profile data 216 may also include additional information about the user including games that have been downloaded by the user and licensing packages that have been issued for those downloaded games, including the permissions associated with each licensing package. Portions of user records 210 can be stored on an individual console, in database 212 or on both. If an individual console retains game records 214 and/or activity record 215 in local data 118, this information can be provided to content management service 120 through network 140. Additionally, the console has the ability to display information associated with game records 214 and/or profile data 216 or advertisements where no a connection to console service 120 is present.

User profile data 216 may also include a user-defined avatar definition, including feature attributes and style attributes, as discussed herein.

Content management service may also include a content store 206 which may be used by client devices 110 to access content provided by content sources 250. Content sources 250 may include third parties that provide audio and visual content for use on client devices. Content sources may provide scheduling information to the advertising service 122 and/or advertisers 260 allowing advertisement targeting to coincide with content provided by the content sources. Content sources may include game developers, broadcast media providers and streaming or on-demand media providers. Using the content store 206, users on client devices 110 may purchase, rent, and otherwise acquire content for use on client devices, with the content provided by content sources provided to the clients through the content management service 120.

Content management service 102 may further include an avatar module 205 for generating an avatar based on information associated with the user. In one embodiment, avatar module 205 generates an avatar based on avatar attributes, such as gender, hair style, hair color, race, clothing, props and animations, etc. The avatar module may allow a user to define a custom avatar to represent the user. The user-defined avatar can then be used in all virtual representations of the user rendered by the client or console management service, and is stored in user profile data 216.

User avatar attributes may be feature attributes or style attributes. For example, the user's avatar feature attributes may include information such as male, bald, fat, slim, mouth type, ear type, facial hair, hairstyle and the like. Style attributes can include clothing, accessories, eyeglasses, headwear, props and the like. Based on a user specification of a set of these avatar attributes, an avatar is generated by avatar module 205. One example of an avatar is shown in FIG. 7A where the avatar is male, has blonde receding hair, a brown goatee with a trench coat, earring and gloves.

As discussed below, the avatar module 205 may be utilized by advertisers 260 to provide the dynamically generated user-based advertising advertisement in accordance with the technology herein by adding to or modifying the user's avatar specification to add custom attributes to the user avatar dynamically—customized for each use in an advertisement. This gives the user familiarity with the avatar and helps associate the product with the user through the user's electronic “self.”

In accordance with the technology, content management service 120 may include an advertising service 122 which allows advertisers 260 to direct advertising to users on client devices 110. In this context, advertisers 260 may specify advertising campaigns that create dynamically generated user-based advertising avatars in a variety of advertising contexts on client devices. Dynamically generated user-based advertisements may comprise avatars constructed to represent the user and associated with a product or service. Avatars may be created by advertisers 260 using a user interface 204 as well as avatar module 205. Specific elements and attributes for the dynamically generated user-based advertising avatar may be elements specific to the advertiser or source of the product or service. These may include custom artwork, clothing or product representations, trademarks and the like. These custom attributes 130 are stored with the advertising service 122, and may be provided to client devices as needed for use in a campaign. Advertisers may alternatively provide campaign and custom attribute information via an Application Programming Interface (API) directly to the content management service 120.

Campaign definitions are stored at 128 for use by the advertising service 122. The campaign definition may include a set of advertisement parameters for a particular product or service, an ideal set of custom attributes which should be applied to a user avatar to create a dynamically generated user-based advertisement avatar, a target audience of users, and other parameters. Advertisers 260 may direct where, when and to whom dynamically generated user-based advertising avatars should be directed based on a number of targeting factors in an advertising campaign. The targeting module 124 can then determine when to render an avatar to a user on a client device 110. In one embodiment, dynamically generated user-based advertising avatars may be directed to users directly from the content management service 120. In other alternatives, the advertising service 122 may deliver dynamically generated user-based advertising avatars and targeting information for one or more campaigns to ad module 116 on client devices with instructions on when and how to display dynamically generated user-based advertising avatars.

The advertisement generated by advertising service 122 may be delivered to client device 110. Alternatively, code for generating dynamic user-based advertising avatars can be delivered to the ad module, and advertisements built on the client for display through the input/output module 114. Examples of how various dynamically generated user-based advertising advertisements may be provided are illustrated in FIGS. 7-10. In one embodiment, the advertisement may be rendered on user interface 112 for the user. The user may interact with the dynamically generated user-based advertising advertisement via voice and/or gesture command or by clicking on the advertisement. For example, when the user clicks on the avatar, the user is redirected to a web site or provided with a video related to the product or service.

Advertising service 122 may further include a targeting module 124 which is configured to provide targeted advertisements to a user of client device 110 based on advertiser provided advertising campaign information and information associated with the user, including user profile information (e.g., user ID, email address, etc.), user avatar attributes, user demographic information, user behavioral information, and other information. In one embodiment, targeting module 124 may generate an advertisement for delivery to the user based campaign information stored in a campaign database 128 and creates dynamically generated user-based advertising avatars. The advertising service communicates with the ad module 116 to generated advertising in the form of dynamically generated user-based advertising avatars to the user in the input/output module 114 as appropriate based on the user's actions on the client, user information and the campaign desired by advertisers.

Advertising service 122 may include a reporting service 126 which tracks user interaction with dynamically generated user-based advertising advertisements and other advertisements, and provides feedback to advertisers 260.

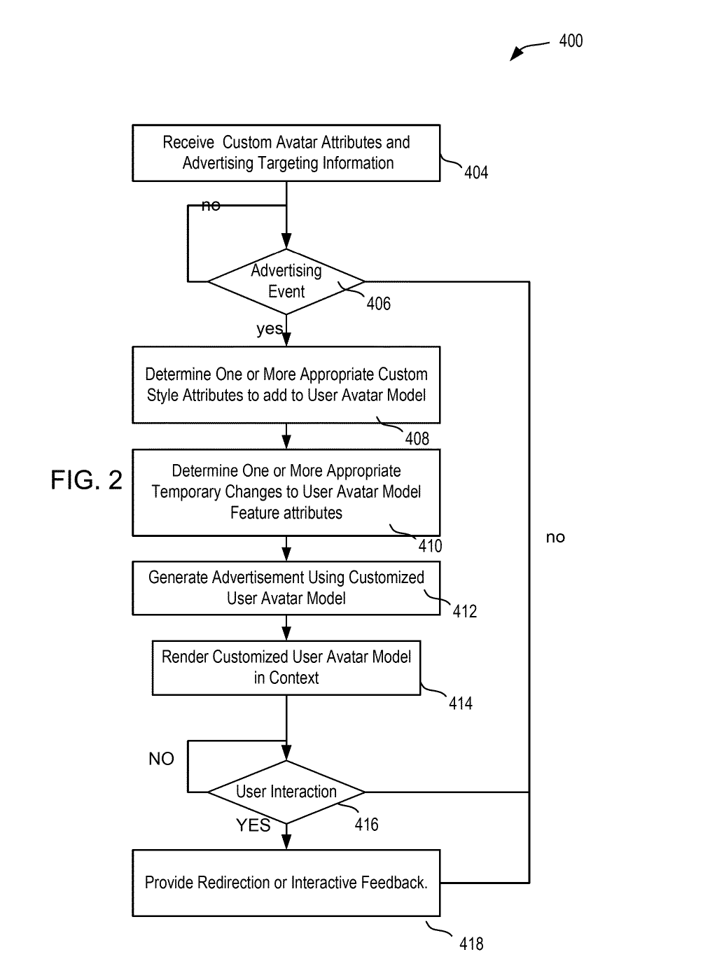

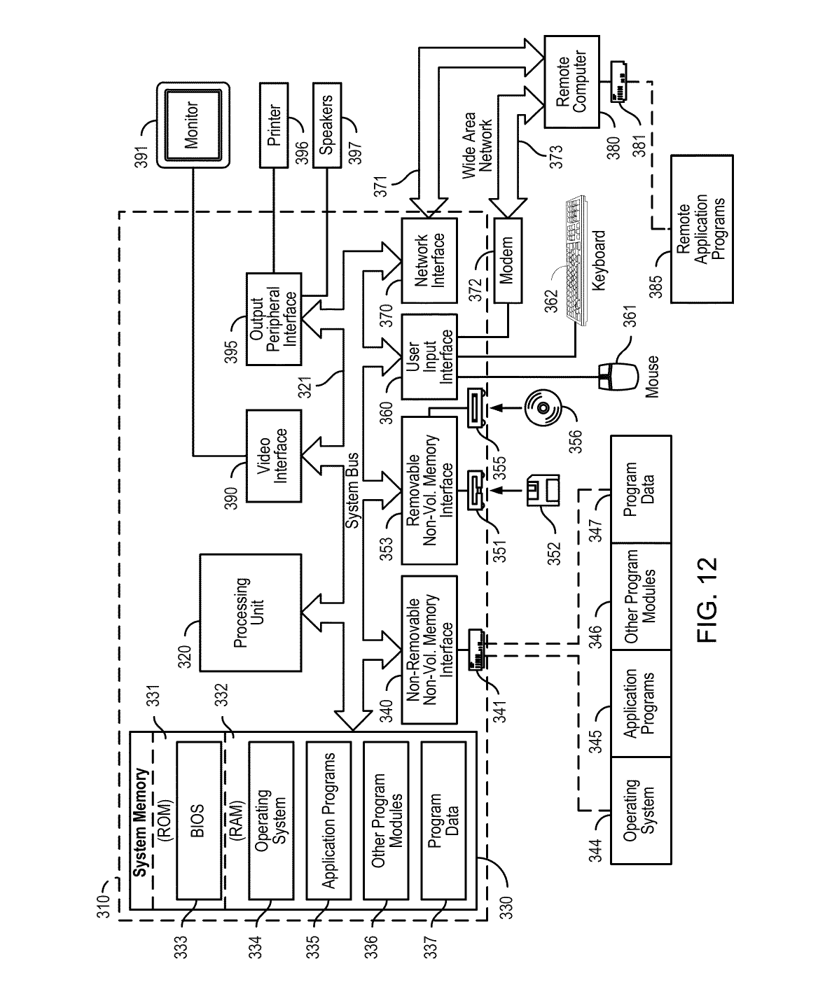

FIG. 2 is a flowchart describing one embodiment of a process for providing dynamically generated user-based advertising avatar to one or more users. In one embodiment, the processing depicted in FIG. 2 may be performed by one or more modules of system 100 as depicted in FIG. 1. In one embodiment, the process of FIG. 2 is performed by a computing environment such as computer 310 in FIG. 12.

At step 404, custom avatar attributes and a campaign definition including advertising targeting information is received via an interface from third parties such as advertisers 260 into the system 100. The interface may be the aforementioned user interface 204 provided by the content management or may comprise an API allowing advertisers to create dynamically generated user-based advertising, provide dynamically generated user-based avatars and advertising campaign information to the system 100. The dynamically generated user-based advertising avatar may have avatar feature attributes, such as gender, hair style, hair color, and race, as well as style attributes such as branded clothing, branded props and animations, all of which become associated with the dynamically generated user-based advertising avatar during an instance of the avatar in an advertisement.

Each campaign may define multiple sets of ideal attributes for use in one instance of an avatar for one advertisement. Campaign information may include target user profile information, avatar attributes, target demographic information, target behavioral information, contextual information, and other information for the persona and the campaign.

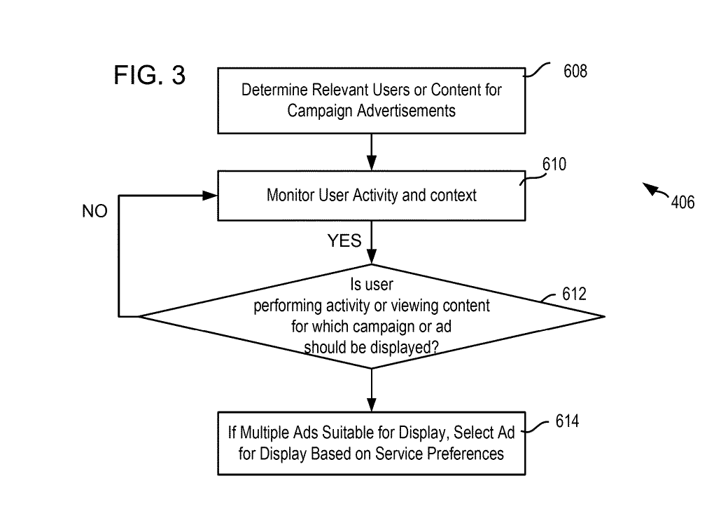

At step 406, an advertisement event is determined. A presentation event may be any of a number of different types of events which cause an advertisement to be provided to a user. An advertisement triggering event is described with respect to FIG. 3 but generally comprises consuming content or performing an activity on client device 110 for which rendering an advertisement is appropriate. This can include but not be limited to providing use of an advertisement with a particular piece of content such as a movie, television show, game, or webpage, a keyword used in a search, displaying the advertisement at a particular time of day, providing an ad based on the interaction of a user with another advertisement displayed on the client, and the like.

Once a event occurs at 406, one or more appropriate custom style attributes which may be used with the dynamically generated user-based advertising avatar are determined at 408. Each ideal set of attributes may contain attributes which, while desirable for the campaign, may be inappropriate or incompatible with the user's avatar. For example, an advertising campaign directed at a particular restaurant might include attributes of branded clothing designed for a younger demographic as well as an older demographic, and the appropriate items should be matched to the demographics associated with the choice of user attributes for the user's own avatar definition.

At 410, one or more appropriate temporary changes to user defined attributes for their avatar are determined. Applying a custom attribute for a user feature in that one generally should not change too many feature attributes or the user recognition of the avatar as originating with the user would be lost. For example, one would not change a balding, fat, bearded male avatar into a skinny, female avatar as association with the user may be lost. However, one may place the head, including the balding hear, beard and other facial features on the body of a skinny female avatar as there would remain at least some association of the original avatar's look with the dynamically generated user-based advertising avatar. A rule set defining which feature attributes may be changed is applied at 410. The number of feature attributes allowed to be changed may be empirically determined by the advertiser.

At 412, an advertisement including the dynamically generated user-based advertising avatar is created. Generation of an advertisement includes determining which product or service campaign should be applied based on the advertising event and the campaign definition, and applying the appropriate avatar attributes.

At 414, the dynamically generated user-based avatar is rendered in context. At 407, a determination is made as to how the user is interacting with client device 110 and the persona rendered in a context suitable for the interaction. For example, it may be appropriate to display the dynamically generated user-based advertising in a corner of the screen when the user is viewing a movie but inappropriate to display the avatar when the user is playing a game. For display in the game context, the dynamically generated user-based advertising may be displayed at an appropriate break point in the game or when the user returns to a menu portion of the game.

At step 416, user interaction with the dynamically generated user-based advertising is monitored. If user interaction with the persona occurs at 416, redirection to additional advertising information or interactive feedback from the avatar may be provided at 418. Step 416 loops to continually monitor for user interaction until the display of the avatar has ended, and the method loops to step 406 to continually monitors for triggering events.

In a further embodiment, it should be understood that to build association between a product or service and the dynamically generated user-based advertising, steps 406-414 (and 416 and 418 if interaction occurs) may be repeated for a duration defined by the advertiser in the advertiser's campaign definition. This duration may comprise a total number of ads, a total number of ads per user, a time duration or other means.

Each repetition of steps 406-414 may create one instance of a dynamically generated user-based advertising avatar. Each instance may be independently created and may appear different—with different features and style attributes—than other instances. In an alternative embodiment, the composition of characteristics for a given instance of a dynamically generated user-based advertising avatar may be saved for use in a different instance of an advertisement

FIG. 3 is a flowchart describing one embodiment of a process for determining an advertising event has occurred and when an advertisement should be presented to a user. FIG. 3 represents one embodiment of step 406 of FIG. 2. Generally, an advertising event defines when an advertisement should be presented to a user, while the parameters of the advertisement campaign determine to whom advertising should be directed.

Referring to FIG. 3, at step 608 a determination of relevant users for a particular campaign and the content of the advertisements is made. This ensures that for a given campaign, advertisements are displayed to the correct target audience. Step 308 may include, for example, determining relevant demographics suitable for a particular advertisement or campaign. Such demographics can include gender, age, income, education, household size, social status and children present. Optionally, campaign information and personas may be distributed to client devices in order to allow rendering of the avatar based advertisement more efficiently on client devices. In such embodiment, the ad module on the client may perform many of the following steps in FIG. 3. In an alternative embodiment, advertising and avatars can be delivered to clients as needed to render advertisements.

At step 610, user activity on the client is monitored to determine whether, at step 612, the user is performing and activity or viewing content or which an ad should be displayed. As noted above, the activity can be consuming a particular type of content or playing a game. In another alternative, the activity can be simply viewing a menu (as illustrated in FIG. 7A). Other factors may enter the determination in step 612 such as the time of the activity, the place in the activity at which the user is participating, the type of activity (participatory vs. non-participatory), and other factors.

If the actions of the user are appropriate to the presentation of an advertisement and the user fulfills a target for the campaign, then at step 614 an additional determination may be made if multiple advertisements are suitable for presentation. If multiple campaigns and/or multiple advertisements meet the user/activity/campaign criteria for presentation to a user, then an advertisement is selected based on advertising service preferences. In one context, preferences can be based on paid frequency of advertising by advertisers. In another context, for example, if an ad has been recently displayed, a different ad may be displayed or no ad may be appropriate. If a user has recently interacted with an ad, a different ad or a different campaign may be appropriate. If an ad should be rendered, the method continues at step 408 of FIG. 2

A campaign definition may include, for example, the number of times a dynamically generated user avatar is to be displayed for a product or service, how often particular ads with dynamically generated user-based advertising avatars should be displayed, and other repetition factors designed to build an association of the dynamically generated user-based advertising with a particular product or service.

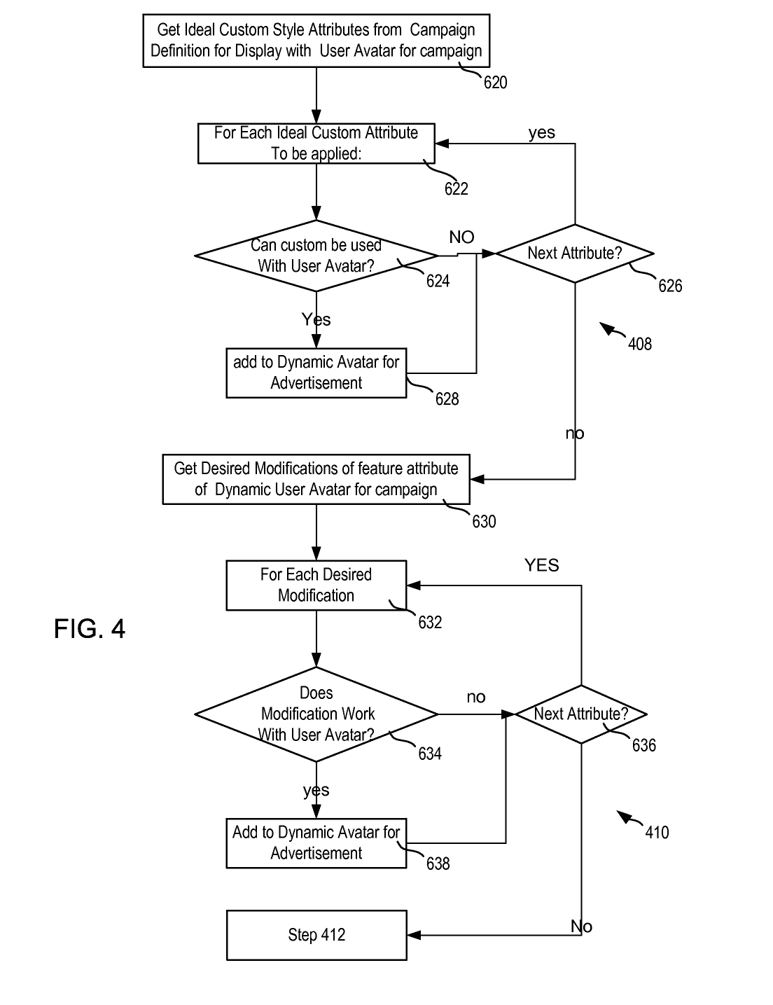

FIG. 4 is a flowchart illustrating one embodiment for performing steps 408 and 410 of FIG. 2. Step 408 comprises determining one or more appropriate custom style attributes to add to user avatar model and determining one or more appropriate temporary changes to user avatar model feature attributes which should be used to generate a given advertisement instance.

At 620, an ideal set of custom attributes provided from a campaign definition are determined. An ideal set is a selection of attributes an advertiser may choose to apply if allowed and compatible with the user's defined avatar. As noted above, not all feature attributes and modifications to the user avatar may be applied to an instance. Whether the custom attribute is applied may depend on user permissions, advertiser settings or system settings.

At 622, for each ideal custom attribute to be applied, at 624 a determination is made as to whether the custom attribute can be use with the user-definition of their avatar. For example, an advertiser may specify a pink dress for use with a user avatar, but the user avatar is defined as a bald, fat, male user with gray hair. In this case, a determination may be made that the dress should not be applied and at 626 the method returns to check the next custom attribute. However, if the attribute is, for example, a shirt bearing a product name, such attribute may be applied to the fat, bald, male user, and at 628 the attribute will be added to the dynamic avatar for this advertising instance.

Once each custom attribute in the ideal set of custom attributes is reviewed, any desired modifications to the user's avatar definition may be examined and determined to be allowable or not. Modification of a user avatar may include modification of a user's feature attributes. For example, an advertiser may seek to change the fat, bald, male avatar by modifying the body definition of the avatar into that of a skinny male. In certain cases, it may or may not be desirable to allow the advertiser to do so.

In cases where some resemblance to the original representation of the user is desired, a set of user features should be maintained. As an example, referring to avatar 920 in FIG. 7A, one might not allow a change to any of the facial features of the avatar in order to preserve the look of the avatar as being associated with that of the user, but may allow changing, for example, the user's ears and removal of the user's glasses, gloves and goatee, as illustrated in the example of FIG. 8.

At 630, an ideal set of desired modifications to existing or defined user feature attributes n are determined. Whether the custom attribute is applied may depend on user permissions, advertiser settings or system settings as well as the advertiser's desire to maintain some resemblance between the user's defined avatar and the advertising avatar instance.

At 632, for each feature attribute to be changed, at 634 a determination is made as to whether the custom attribute can be use with the user-definition of their avatar. For example, an advertiser may specify a change to user's ears, but the user avatar is defined as a long haired female whose attribute for hair covers the avatar's ears. In this case, a determination may be made that the ears should not be applied and at 636 the method returns to check the next custom attribute. However, if the attribute is, for example, smile to be applied to an un-smiling face, such attribute may be applied to user avatar, and at 638 the attribute will be added to the dynamic avatar for this advertising instance.

When all attributes specified by an advertiser have been dealt with, the method continues at step 412.

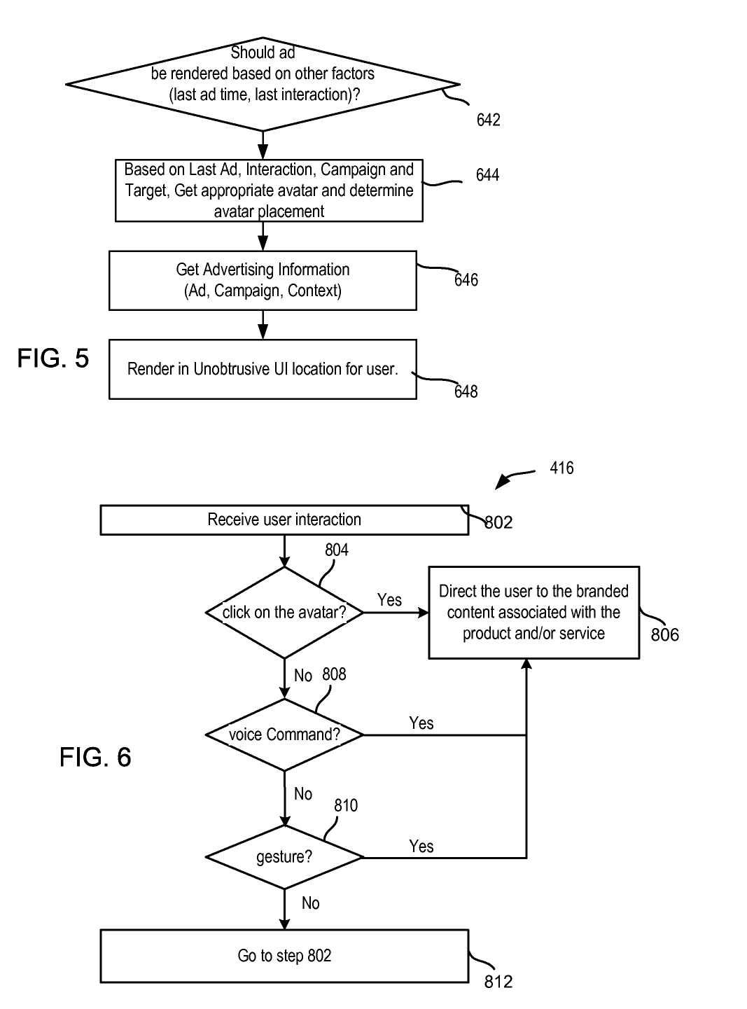

FIG. 5 is a flowchart depicting a process for rendering a customized user avatar model in content in an advertisement. At 642, a determination is made as to whether non-campaign related factors merit display of an advertisement. For example, if an ad has been recently displayed, a different ad may be displayed or no ad may be appropriate. If a user has recently interacted with one type of ad, a different ad or a different campaign may be appropriate. If an ad should be rendered, at step 644 the appropriated branded persona is retrieved and appropriate rendering is determined. At 646 advertising information associated with the avatar is retrieved. Such information can include text, animation, audio or other information which should be displayed with the avatar or actions which the avatar should take when displayed. At 648 the branded persona avatar is rendered. In a location which is not obtrusive to the user's interaction with the client device.

FIG. 6 is a flowchart describing one embodiment of a process for interacting with an advertisement. The processing depicted in FIG. 4 may be performed by a user and one or more modules implemented in client device 110 as depicted in FIG. 1.

FIG. 6 will be described with reference to FIGS. 7A and 7B. An exemplary dynamically generated user-based advertising avatar is illustrated in FIG. 7A. As depicted in FIG. 7A, a user interface for a “social” interaction user interface screen illustrates a user's avatar 902 and a friend's avatar 904 rendered in the social menu environment. Avatar 902a is depicted in FIG. 7B as a digital spokesperson to promote a restaurant chain and its product and/or service. A user may interact with the advertisement, e.g., by clicking on avatar. Upon interaction, the user is redirected to branded content which displays more information about the brand as depicted in FIG. 7C.

With reference to FIG. 6, at step 802, an interaction with the avatar is received at a client device, such as client device 110 of FIG. 1. The advertisement depicted in FIG. 7B depicts a user's avatar promoting a certain brand of product and/or service. In one embodiment, the advertisement may be rendered on a display of client device 110 in a menu interface such as that used in the Xbox 360®, as shown in FIGS. 7A and 7B.

At step 804, the process of FIG. 6 detects if a user has clicked on the avatar. For example, a user may click on the avatar using a controller (e.g., Xbox controller). Upon detecting that a user has clicked on the avatar, at step 806, the user may be redirected to the branded content associated with the product or service, e.g., a web site, a video or audio related to the product or service. An example of branded content is illustrated in FIG. 7C.

At step 808, the process of FIG. 6 detects a voice command from a user requesting more information associated with the advertiser. For example, input/output module 114 of client device 110 may detect a user voice command, such as “more information.” If the process of FIG. 6 detects a user voice command requesting more information associated with the advertiser, then at step 806, the user is redirected to the branded content associated with the product or service, e.g., a web site, a video or audio related to the product or service.

At step 810, the process of FIG. 6 may detect user gestures indicating that the user may like to obtain more information associated with the advertiser. For example, input/output module 114 of client device 110 may detect one or more user gestures, such as a hand pointing motion at the avatar. If the process of FIG. 6 detects such user gestures, then at step 806, the user is redirected to the branded content associated with the product or service, e.g., a web site, a video or audio related to the product or service. Otherwise, at step 812, the process of FIG. 6 returns to step 802 for a next advertisement that may be received at the client device.

As depicted in FIG. 7B, the dynamically generated user-based avatar 902a is rendered in a console user interface. Avatar 902a shares some characteristics as the user avatar 902, but is now wearing a new cowboy hat with a “C's” logo and branded western clothing displaying “Contoso's BBQ”. The dynamically generated user-based avatar 902a has similar facial features to the user avatar 902, but the avatar's shirt and gloves have changed. Nevertheless, the dynamically generated user-based avatar 902a is rendered so that the avatar resembles the user avatar 902 and is familiar to the user.

Additional information or branded content, as depicted in FIG. 7C, may include specialized advertising, a product store, or additional information or incentives about the product represented by the dynamically generated user-based advertising. In this example, FIG. 7C is a landing page which is displayed in the same interface of the avatar, and includes interactive features allowing the user to obtain further information about the advertiser. The interface in FIG. 7C may include selectable items and links to still further information. In a further aspect, providing additional information about the product or service includes modifying the dynamically generated user-based advertising avatar to respond to interactions (such as answering questions) or allowing the avatar to interact with additional avatars. Such interaction may be by way of any of the input/output mechanisms discussed herein.

FIG. 7D depicts another dynamically generated user-based avatar 902b wherein additional changes to the user avatar 902 have been applied. In this instance, the user's shirt, pants, headwear, glasses and gloves have all changed. However, the user avatar's facial features and earring have not. Even with the numerous changes made to the user avatar definition, the dynamically generated user-based avatar is rendered is still recognizable as associated with the user avatar 902.

FIG. 7D depicts the display of the dynamically generated user-based avatar 902d in an advertisement in a television display during a science fiction audio visual presentation, such as a movie. In this context, the avatar is displayed in an unobtrusive area of the screen which has been determined to be unlikely to have action in the movie displayed, and in conjunction with the content providers, the advertising service is aware that the movie is being broadcast and that the user is tuned to the movie, or that the movie is being displayed on the user's video display by interaction of the ad module 116 with the client. In this instance, the dynamically generated user-based avatar 902d is rendered with even more changes from the user avatar 902 shown in FIG. 7A. The dynamically generated user-based avatar 902d is rendered with branded clothing, and feature attributes including the user avatar's ears have been changed to pointy ears, and the user avatar's goatee has been removed. The user avatar 902 glasses and earring have been removed as well. The advertisement encourages the view to “have an ACME soda”.

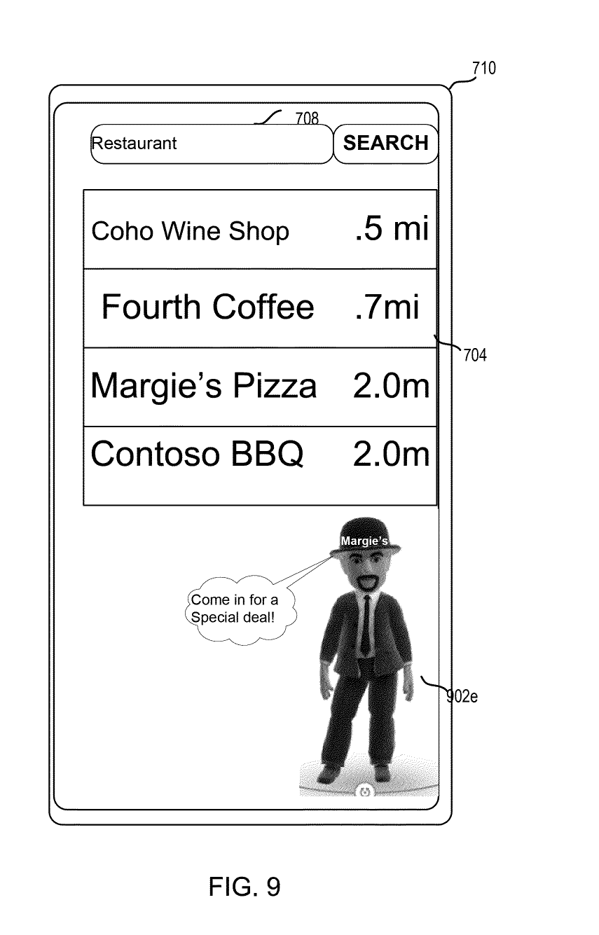

FIG. 9 depicts the display of a dynamically generated user-based advertising avatar 902e in a mobile device. A typical device 710 includes a search application which may be a standalone application or a search enabled by a mobile browser. In this example, a user has searched for a “restaurant” in search box 708 and received a list of results 704. A dynamically generated user-based advertising avatar 902e representing the restaurant is dressed in a dapper suit with a bowler had, all added to the facial attributes of the user avatar 902. The dynamically generated user-based pizza delivery person for “Margie's Pizza” may be displayed on the mobile device in an unobtrusive region of the display.

FIG. 10 depicts the display of the dynamically generated user-based avatar 902f in advertising in a web page, and illustrates an example of a dynamically generated user-based avatar 902e rendered where only one style attribute—the addition of a branded advertising hat to the user avatar—has been made. A web browser 700 includes a page 712 displaying, for example, a personal calendar 750. The page display may include a banner advertisement 755 as well as a dynamically generated user-based advertising avatar 902f. Information on the type of dynamically generated user-based advertising can be derived from information in the page 712, including for example an event 774 indicating a “pizza party” is scheduled in the calendar. In this example, the dynamically generated user-based avatar 902f wears a pizza store hat.

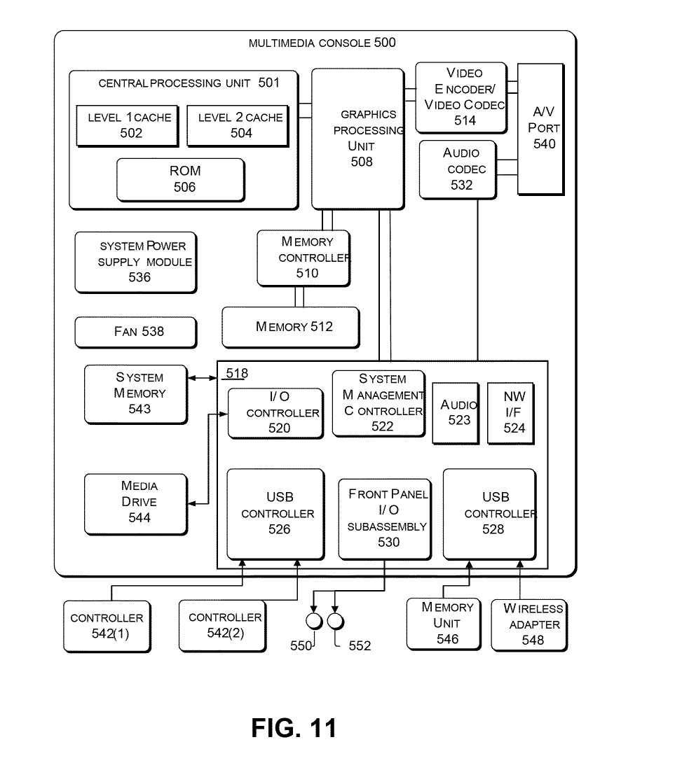

FIG. 11 illustrates an example of a computing environment including a multimedia console (or gaming console) 500 that may be used to implement client device 110 of FIG. 1. As shown in FIG. 11, multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an NV (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the NV port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the one may not change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches.

FIG. 12 illustrates an example of a computing device for implementing the present technology. In one embodiment, the computing device of FIG. 12 provides more detail for client device 110 and content management service 120 of FIG. 1. The computing environment of FIG. 10 is one example of a suitable computing environment and is not intended to suggest any limitation as to the scope of use or functionality of the present technology. Neither should the computing environment be interpreted as having any dependent requirement relating to any one or combination of components illustrated in the exemplary operating environment.

The present technology is operational in numerous other general purpose or special computing system environments or configurations. Examples of well known computing systems, environments, and/or configurations that may be suitable for implementing the present technology include, but are not limited to personal computers, server computers, laptop devices, multiprocessor systems, microprocessor-based systems, network PCs, minicomputers, mainframe computers, distributed computing environments that include any of the above systems or the like.

The present technology may be described in the general context of computer-executable instructions, such as program modules, being executed by a computer. Generally, program modules include routines, programs, objects, components, data structures, etc. that perform a particular task or implement particular abstract data types. The present technology may be also practiced in distributed computing environments where tasks are performed by remote processing devices that are linked through a communications network. In a distributed computing environment, program modules may be located in both local and remote computer storage media including memory storage devices.

With reference to FIG. 10, an exemplary system for implementing the technology herein includes a general purpose computing device in the form of a computer 310. Components of computer 310 may include, but are not limited to, a processing unit 320, a system memory 330, and a system bus 321 that couples various system components including system memory 330 to processing unit 320. System bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 12 illustrates operating system 334, application programs 335, other program modules 336, and program data 337.

Computer 310 may also include other removable/non-removable, volatile/nonvolatile computer storage media. By way of example only, FIG. 12 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 341 is typically connected to system bus 321 through a non-removable memory interface such as interface 340, and magnetic disk drive 351 and optical disk drive 355 are typically connected to system bus 321 by a removable memory interface, such as interface 353.

The drives and their associated computer storage media discussed above and illustrated in FIG. 12 provide storage of computer readable instructions, data structures, program modules and other data for computer 310. In FIG. 7, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to system bus 321 via an interface, such as a video interface 390. In addition to the monitor, computers may also include other peripheral output devices such as speakers 397 and printer 396, which may be connected through an output peripheral interface 390.

Computer 310 may operate in a networked environment using logical connections to one or more remote computers, such as a remote computer 380. Remote computer 380 may be a personal computer, a server, a router, a network PC, a peer device or other common network node, and typically includes many or all of the elements described above relative to computer 310, although only a memory storage device 381 has been illustrated in FIG. 12. The logical connections depicted in FIG. 12 include a local area network (LAN) 371 and a wide area network (WAN) 373, but may also include other networks. Such networking environments are commonplace in offices, enterprise-wide computer networks, intranets and the Internet.

When used in a LAN networking environment, computer 310 is connected to LAN 371 through a network interface or adapter 370. When used in a WAN networking environment, computer 310 typically includes a modem 372 or other means for establishing communications over WAN 373, such as the Internet. Modem 372, which may be internal or external, may be connected to system bus 321 via user input interface 360, or other appropriate mechanism. In a networked environment, program modules depicted relative to computer 310, or portions thereof, may be stored in the remote memory storage device. By way of example, and not limitation, FIG. 12 illustrates remote application programs 385 as residing on memory device 381. It will be appreciated that the network connections shown are exemplary and other means of establishing a communications link between the computers may be used.

Those skilled in the art will understand that program modules such as operating system 334, application programs 345, and data 337 are provided to computer 310 via one of its memory storage devices, which may include ROM 331, RAM 332, hard disk drive 341, magnetic disk drive 351, or optical disk drive 355. Hard disk drive 341 is used to store data 337 and the programs, including operating system 334 and application programs 345.

When computer 310 is turned on or reset, BIOS 333, which is stored in ROM 331 instructs processing unit 320 to load operating system 334 from hard disk drive 341 into RAM 332. Once operating system 334 is loaded into RAM 332, processing unit 320 executes the operating system code and causes the visual elements associated with the user interface of the operating system to be displayed on the monitor. When a user opens an application program 345, the program code and relevant data are read from hard disk drive 341 and stored in RAM 332.

Aspects of the present technology may be embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. In accordance with an illustrative embodiment of the Internet, a plurality of local LANs and a WAN can be interconnected by routers. The routers are special purpose computers used to interface one LAN or WAN to another.

Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art. Furthermore, computers and other related electronic devices can be remotely connected to either the LANs or the WAN via a digital communications device, modem and temporary telephone, or a wireless link. The Internet has recently seen explosive growth by virtue of its ability to link computers located throughout the world. As the Internet has grown, so has the WWW.

As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Web sites” throughout the Internet. Additionally, software programs that are implemented in computer 310 and communicate over the Web using the TCP/IP protocol, are part of the WWW, such as JAVAS applets, instant messaging, e-mail, browser plug-ins, Macromedia Flash, chat and others. Other interactive hypertext environments may include proprietary environments such as those provided by an number of online service providers, as well as the “wireless Web” provided by various wireless networking providers, especially those in the cellular phone industry. It will be appreciated that the present technology may apply in any such interactive communication environments. For purposes of discussion, the Web is used as an exemplary interactive hypertext environment with regard to the present technology.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVAS programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Microsoft's Internet Explorer, is a software application program for providing a user interface to the WWW. Using the web browser via a remote request, the web browser requests the desired hypertext document from the appropriate web server using the URL for the document and the Hypertext Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

For purposes of this document, reference in the specification to “an embodiment,” “one embodiment,” “some embodiments,” or “another embodiment” are used to described different embodiments and do not necessarily refer to the same embodiment.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing an advertisement to a user, comprising:
receiving advertising attributes and advertising information including targeting information for an advertisement to be delivered to the user;
acquiring user information including a virtual user representation and user activity on a processing device;
creating a dynamically generated user-based avatar having at least a portion of the advertising attributes and based on the virtual user representation;
generating an advertisement based on the dynamically generated user-based advertising avatar and the advertising information; and
displaying the advertisement to the user.

2. The method of claim 1, further comprising:
detecting user interaction with the dynamically generated user-based advertising avatar; and
providing additional information content associated with a product or service to the user in response to said detecting.

3. The method of claim 2 wherein the user interaction includes any of one of: a user interacting with the dynamically generated user-based advertising avatar through a visual interface element; a user interacting with the dynamically generated user-based advertising avatar through a voice command; and a user interacting with the dynamically generated user-based advertising avatar through physical gesture.

4. The method of claim 1, wherein the information associated with the user includes user activity with content consumption on the processing device.

5. The method of claim 1 wherein the step of acquiring information includes acquiring a definition of a user avatar comprising a set of attributes, the attributes including feature attributes and style attributes, the avatar comprising at least a portion of the virtual user representation.

6. The method of claim 1 wherein the step of creating includes creating a dynamically generated user based avatar having at least a portion of a set of user attributes defining a user avatar and a portion of the advertising attributes applied to the user avatar.

7. The method of claim 6 wherein the at least portion of a set of user attributes contains a plurality of user feature attributes allowing recognition of the dynamically generated user based avatar as associated with the user.

8. The method of claim 6 wherein the step of creating includes determining conflicts between custom attributes and user attributes, and preventing application of custom attributes in conflict with user attributes.

9. The method of claim 1 further including the step of determining target users from the targeting information and wherein said steps of acquiring, creating, generating and displaying are performed for at least a portion of the target users.

10. One or more storage devices containing processor readable code for programming one or more processors to perform a method comprising:
acquiring a definition of a user avatar comprising a set of attributes, the attributes including feature attributes and style attributes;
receiving custom attributes to create a dynamically generated user-based avatar;
receiving advertising information including targeting information using the dynamically generated user-based avatar;
creating a dynamically generated user based avatar having at least a portion of the set attributes of the user avatar and a portion of the custom attributes;
acquiring information associated with user activity on a device capable of displaying the dynamically generated user-based advertising avatar;
generating an advertisement based on the dynamically generated user-based advertising avatar and the targeting information; and
rendering the advertisement to the user in a manner unobtrusive to the activity.

11. The one or more storage devices of claim 10, wherein said creating includes:
selecting one or more custom attributes from a set of ideal attributes;
determining ones of the custom attributes to apply to the definition of a user avatar, said determining leaving a subset of the set attributes of the user avatar.

12. The one or more storage devices of claim 11 wherein the step of determining one of the custom attributes includes determining at least a portion of a set of custom style attributes and at least a portion of a set of feature attributes.

13. The one or more storage devices of claim 12 wherein the advertising information includes instructions for content of advertising to be associated with the dynamically generated user-based avatar during said generating.

14. The one or more storage devices of claim 13, further comprising:
detecting user interaction with the dynamically generated user-based avatar; and
providing additional information content associated with a product or service to the user in response to said detecting.

15. The one or more storage devices of claim 14, wherein acquiring information associated with the user includes user profile information, demographic information, and contextual information.

16. The one or more storage devices of claim 14, further comprising:
rendering the advertisement to the user in a manner unobtrusive to user activity.

17. A system for providing an advertisement to a user of a content management service, comprising:
a memory; and
one or more processors, the one or more processors in communication with the memory, the one or more processors configured to perform the steps of:
receiving advertising attributes, the advertising attributes associated with a product or service and comprising at least part of a campaign definition, the campaign definition defining when to generate a dynamically generated user-based advertising avatar, a target audience, and information associated with a dynamically generated user-based advertising avatar for an advertisement;
acquiring user-defined avatar definitions, each user-defined avatar definition representing a user;
receiving information associated with a user, the information associated including user profile information and user activity on a client device;
creating a dynamically generated user based avatar having at least a portion of a set of user attributes defining a user avatar and a portion of the advertising attributes applied to the user avatar; and
displaying an advertisement using the dynamically generated user based avatar having at least a portion of a set of user attributes defining a user avatar and a portion of the advertising attributes applied to the user avatar.

18. The system of claim 17, wherein: at least portion of a set of user attributes contains a plurality of user feature attributes allowing recognition of the dynamically generated user based avatar as associated with the user.

19. The system of claim 17, wherein creating includes determining conflicts between custom attributes and user-defined attributes, and preventing application of custom attributes in conflict with user-defined attributes.

20. The system of claim 17 wherein steps of receiving information associated with a user, providing an advertisement based on the advertising avatar to the user are repeated for a duration defined by the campaign definition.
